(19) United States
(12) Patent Application Publication
(10) Pub. No.: US 2021/0264006 A1
(43) Pub. Date: Aug. 26, 2021

(54) DYNAMIC BIOMETRIC UPDATING

(71) Applicant: Lenovo (Singapore) Pte. Ltd., Singapore (SG)

(72) Inventors: Russell Speight VanBlon, Raleigh, NC (US); Robert James Kapinos, Durham, NC (US); Scott Wentao Li, Cary, NC (US); Robert James Norton, Jr., Raleigh, NC (US)

(21) Appl. No.: 16/795,938

(22) Filed: Feb. 20, 2020

(51) Int. Cl. G06F 21/32; G06F 21/45

(52) U.S. Cl. CPC G06F 21/32; G06F 21/45

(57) ABSTRACT

One embodiment provides a method, including: detecting, using one or more sensors of an information handling device, at least two biometric inputs provided by a user during an authentication process; authenticating the user responsive to determining that at least one biometric input of the at least two biometric inputs shares a threshold level of similarity with stored biometric information; determining, using a processor, that another biometric input of the at least two biometric inputs does not share the threshold level of similarity with the stored biometric information; and updating the stored biometric information with retained characteristics of the another biometric input. Other aspects are described and claimed.

### BACKGROUND

Users frequently utilize their information handling devices (“devices”), for example smart phones, tablets, smart speakers, laptop and/or personal computers, and the like, to access and interact with various different types of applications/content. Some devices employ authentication systems that may require a user to validate their identity prior to granting the user access to the system or to applications resident on the system. These authentication systems may rely on biometric information to facilitate the validation process.

### BRIEF SUMMARY

In summary, one aspect provides a method, comprising: detecting, using one or more sensors of an information handling device, at least two biometric inputs provided by a user during an authentication process; authenticating the user responsive to determining that at least one biometric input of the at least two biometric inputs shares a threshold level of similarity with stored biometric information; determining, using a processor, that another biometric input of the at least two biometric inputs does not share the threshold level of similarity with the stored biometric information; and updating the stored biometric information with retained characteristics of the another biometric input.

Another aspect provides an information handling device, comprising: at least one sensor; a processor; detect at least two biometric inputs provided by a user during an authentication process; authenticate the user responsive to determining that at least one biometric input of the at least two biometric inputs shares a threshold level of similarity with stored biometric information; determine that another biometric input of the at least two biometric inputs does not share the threshold level of similarity with the stored biometric information; and update the stored biometric information with retained characteristics of the another biometric input.

A further aspect provides a product, comprising: a storage device that stores code, the code being executable by a processor and comprising: code that detects at least two biometric inputs provided by a user during an authentication process; code that authenticates the user responsive to determining that at least one biometric input of the at least two biometric inputs shares a threshold level of similarity with stored biometric information; code that determines that another biometric input of the at least two biometric inputs does not share the threshold level of similarity with the stored biometric information; and code that updates the stored biometric information with retained characteristics of the another biometric input.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of dynamically updating biometric information used in an authentication process.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

A variety of different authentication techniques of differing security strengths may be utilized by a system to verify an individual's identity. The selection of the particular technique may be dictated by the level of secure access management an entity wishes to deploy. For instance, single-factor authentication is commonly used when accessing non-sensitive information (e.g., a mobile game, media player, etc.) and authentication may be achieved via a simple username and password/passcode/pin combination match. Two-factor authentication (“2FA”) is generally utilized for accounts or applications that have some access to sensitive data (e.g., corporate emails, social media accounts, etc.) and authentication may conventionally be achieved via an initial request for a username/password pair followed by another request to input a second security measure (e.g., token-based one-time passcode (“OTP”), etc.). Adding in a third, fourth, or even fifth authentication factor expands the security of any access management solution into the realm of multi-factor authentication (“MFA”). MFA can be deployed for controlling access to the most sensitive types of data (e.g., financial records, medical information, government databases, etc.) and can be achieved by incorporating several factors, which can include: passwords, secret questions, OTPs, biometrics, location, user behavior, etc.

Biometric based 2FA and MFA authentication techniques essentially replace what information users have (e.g., tokens, etc.) and what information users know (e.g., passcodes, etc.) with what they are. More particularly, these biometric techniques may detect various user characteristics (e.g., fingerprints, face, iris, voice, behavioral motions, etc.) and match them with stored biometric information associated with the user to perform authentication. However, it is common for a user's physical characteristics and mannerisms to change over time. For example, as individuals age their facial features, voice tone and pitch, behavior, etc. all may change. When this change occurs, the system may have issues authenticating a user.

Accordingly, an embodiment provides a method for dynamically updating biometric information. In an embodiment, at least two biometric inputs provided by a user during an authentication process may be detected by sensors of a device. Detectable types of biometric input may include face recognition, iris recognition, fingerprint recognition, voice recognition, behavioral recognition, and the like. An embodiment may then authenticate the user responsive to determining that at least one of the biometric inputs shares a threshold level of similarity (e.g., 90% similarity, 99% similarity, etc.) with stored biometric information for that biometric type. Additionally, an embodiment may determine that at least one other biometric input does not share the threshold level of similarity with the stored biometric information for its particular biometric type. Responsive to the foregoing, an embodiment may dynamically update the stored biometric information with detected characteristics associated with the at least one other biometric input. Such a method may eliminate the need for a user to continually retrain the system's stored biometric information.

The illustrated example embodiments will be best understood by reference to the figures. The following description is intended only by way of example, and simply illustrates certain example embodiments.

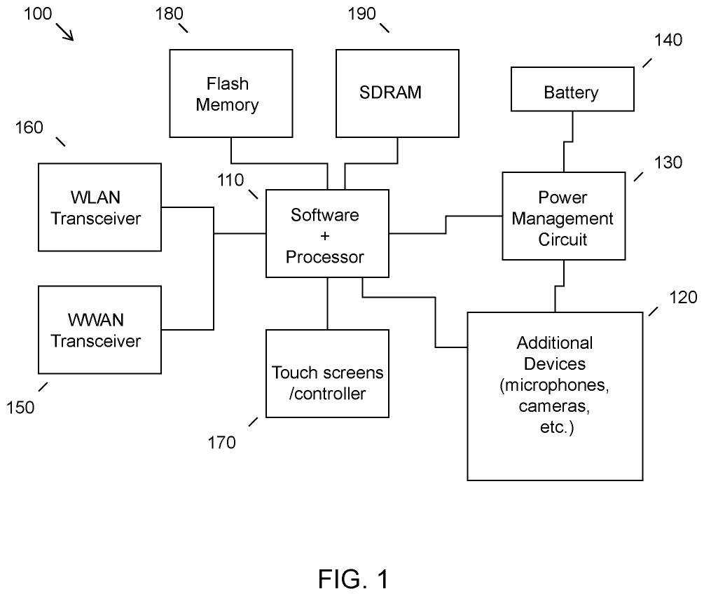

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

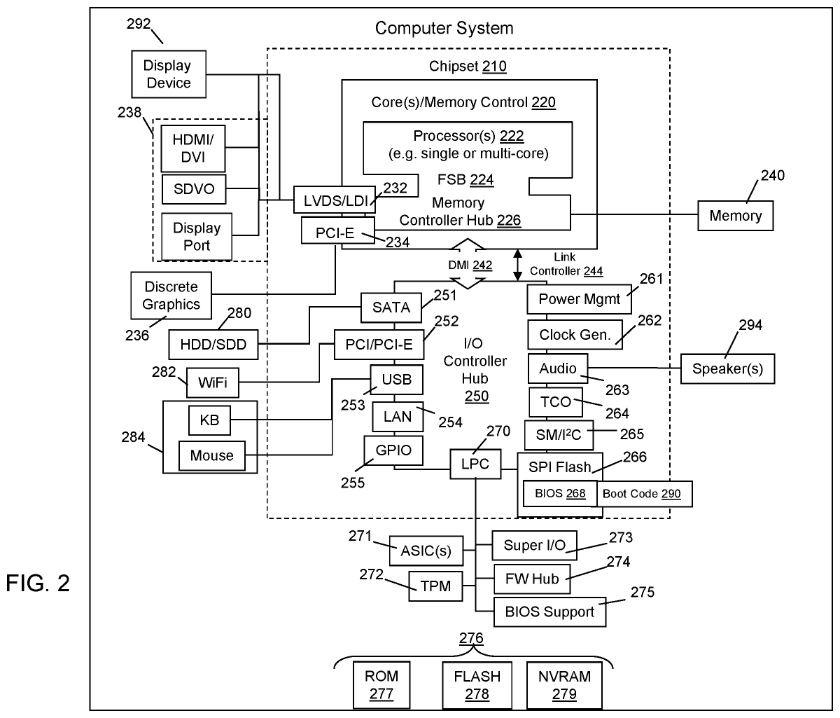

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices capable of capturing and processing biometric data from a user. For example, the circuitry outlined in FIG. 1 may be implemented in a smart phone or tablet embodiment, whereas the circuitry outlined in FIG. 2 may be implemented in a laptop.

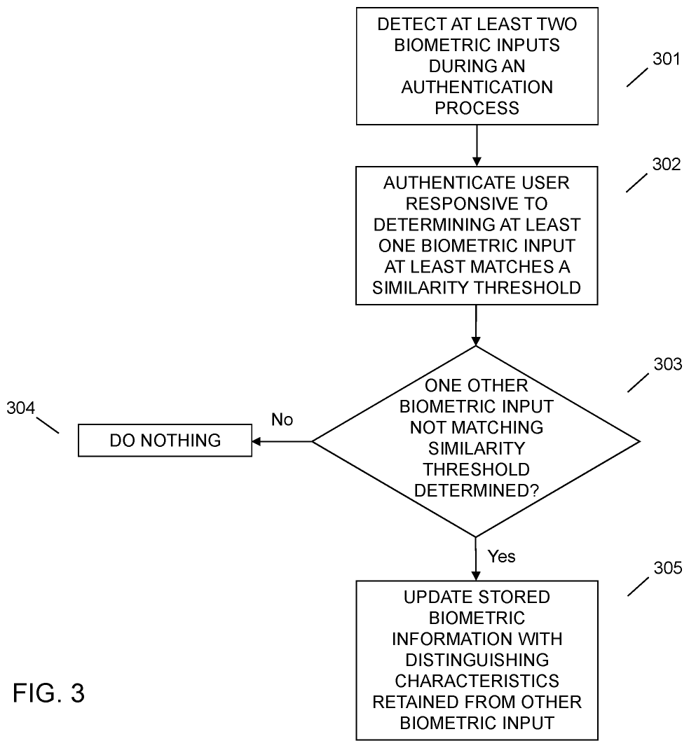

Referring now to FIG. 3, an embodiment provides a method for dynamically updating biometric information associated with a user. At 301, an embodiment may detect at least two biometric inputs provided by a user during an authentication process. In an embodiment, the biometric inputs may be unique from each other and may be selected from a variety of conventional biometric input types (e.g., face input, iris input, fingerprint input, audio input, gesture input, signature input, keystroke input, etc.). The biometric inputs may be detected using one or more sensors integrally or operatively coupled to the device (e.g., camera sensors, microphones, touch-sensitive displays, etc.) and may be processed using one or more conventional biometric input processing techniques (e.g., face recognition, iris recognition, fingerprint recognition, voice recognition, gesture recognition, signature recognition, behavioral recognition, etc.).

In an embodiment, the detection of the biometric inputs may occur during an authentication process. The authentication process may be initiated at various points during device use (e.g., at device initialization to log into a user profile, when a user attempts to access content in an application, etc.). In an embodiment, the required number of biometric inputs needed for successful authentication may remain consistent throughout the device. For example, each instance of requested authentication may require a user to provide: two types of biometric inputs, three types of biometric inputs, etc. Alternatively, the number of biometric inputs required to be provided in the authentication process may be dependent on a security level of a device or an application on a device. For example, logging into a user profile at startup may require a user to provide two biometric inputs whereas accessing content in a banking application may require a user to provide three or more biometric inputs. Additionally or alternatively, the number of required biometric inputs and/or the types of biometric inputs requested may be selected at random each time execution of an authentication process is triggered.

At 302, an embodiment may authenticate the user responsive to determining that at least one of the biometric inputs shares a threshold level of similarity with stored biometric information for that biometric type. In an embodiment, a device may have access to a database (e.g., stored locally on the device, stored remotely on another device or server, etc.) that comprises stored biometric information that was previously provided or obtained from an authorized user (e.g., during an authentication setup training period, etc.). The stored biometric information may comprise data associated with each respective biometric input type (e.g., facial data of an authorized user, voice data of an authorized user, etc.). When biometric input data is received or detected (e.g., during an authentication process, etc.), each set of input data may be compared against its corresponding biometric input type. For example, voice input data may be compared against a stored voice signature for an authorized user whereas face input data may be compared against stored facial features associated with the authorized user.

In an embodiment, the threshold level may be originally established by a manufacturer and/or later adjusted by a user. In an embodiment, the threshold level may remain consistent across all applications on a device. Alternatively, the threshold level may dynamically change based upon a security level associated with an application. For example, access to a social media profile may only require a 90% similarity threshold whereas access to an application containing more sensitive content (e.g., a banking application, a work application, etc.) may require a 99% similarity threshold.

At 303, an embodiment may determine whether another of the biometric inputs does not share a threshold level of similarity with stored biometric information for that biometric input type. Responsive to determining, at 303, that all of the biometric inputs share the threshold level of similarity with their respective biometric input types in the stored biometric information, an embodiment may, at 304, take no additional action. Conversely, responsive to determining, at 303, that at least one of the biometric inputs does not share a threshold level of similarity with its corresponding biometric type in the stored biometric information, an embodiment may, at 305, update the stored information for the relevant biometric type with characteristics of this threshold-failing biometric input. Thereafter, when a user subsequently is prompted to provide the biometric input that originally failed to meet the similarity threshold, a similarity match may be identified.

As a non-limiting example of the foregoing concepts, a user may be prompted to provide two biometric inputs, e.g., face input and voice input. Embodiments of the system may analyze each of the biometric inputs and determine that the user's face matches with 99% certainty but the voice input matches with only 70% certainty. Because at least one biometric input (i.e., the face input) produces a result that exceeds a similarity threshold, an embodiment may identify the user as an authorized user. Additionally, an embodiment may identify the difference in characteristics between the threshold-failing voice input and a known voice signature of the authorized user and thereafter utilize these differences to dynamically update or re-train the voice biometrics moving forward.

In an embodiment, the stored biometric information may be updated responsive to identifying a single threshold-failing event. More particularly, an embodiment may update the stored biometric information after a single instance of a biometric input failing to meet the similarity threshold is identified. Alternatively, the stored biometric information may only be updated after an embodiment detects a predetermined number of failed matches (e.g., 3 mismatches, 5 mismatches, etc.) for that biometric input type. For example, using the scenario described in the previous paragraph, an embodiment may update the stored voice biometrics for an authorized user responsive to identifying that received voice input does not meet the similarity threshold for voice input during 5 distinct authentication sessions. In another similar example, an embodiment may update the stored biometric input responsive to identifying a predetermined number of failed matches within a predetermined period of time (e.g., in one hour, one day, one week, etc.). In yet another example, an embodiment may update the stored biometric input responsive to identifying that the differences are similar between the biometric input and the stored biometrics across a predetermined number of instances (e.g., 3 instances, 5 instances, etc.) of authentication failure. For example, in the case of voice input, an embodiment may identify that the user voice input consistently displays the same distinguishing characteristics from the stored voice input for an authorized user (e.g., difference in pitch, cadence, tone, etc.).

The various embodiments described herein thus represent a technical improvement to conventional methods for updating stored biometric information that is referenced in an authentication process. Using the techniques described herein, an embodiment may detect at least two biometric inputs provided by a user during an authentication process. An embodiment may then authenticate the user responsive to determining that one of the biometric inputs at least matches a similarity threshold associated with a type of biometric information that is stored in an accessible database. Additionally, an embodiment may determine whether another biometric input provided during the authentication process at least matches a similarity threshold associated with its corresponding type of biometric information. Thereafter, responsive to determining that the other biometric input does not at least matches the similarity threshold, an embodiment may update the stored biometric information with retained characteristics of the threshold-failing biometric input. Such a method may negate the need for users to manually update stored biometric information and may correspondingly ensure that authentication processes operate efficiently.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
detecting, using one or more sensors of an information handling device, at least two biometric inputs provided by a user during an authentication process;
authenticating the user responsive to determining that at least one biometric input of the at least two biometric inputs shares a threshold level of similarity with stored biometric information;
determining, using a processor, that another biometric input of the at least two biometric inputs does not share the threshold level of similarity with the stored biometric information; and
updating the stored biometric information with retained characteristics of the another biometric input.

2. The method of claim 1, wherein each of the at least two biometric inputs is associated with a biometric type.

3. The method of claim 2, wherein the biometric type is selected from the group consisting of face recognition, iris recognition, fingerprint recognition, voice recognition, and behavioral recognition.

4. The method of claim 2, wherein the updating comprises updating the biometric type associated with the another biometric input in the stored biometric information.

5. The method of claim 1, wherein the updating comprises updating the stored biometric information responsive to identifying that the another biometric input does not share the threshold level of similarity with the stored biometric information for a predetermined number of iterations of the authentication process.

6. The method of claim 1, wherein the updating comprises updating the stored biometric information responsive to identifying that the another biometric input does not share the threshold level of similarity with the stored biometric information for a predetermined number of iterations of the authentication process conducted within a predetermined period of time.

7. The method of claim 1, wherein the updating comprises automatically updating the stored biometric information without receiving additional training input.

8. The method of claim 1, further comprising:
receiving, after the updating, the another biometric input in another iteration of the authentication process; and
identifying that the another biometric input shares the threshold level of similarity with the stored biometric information.

9. The method of claim 1, further comprising adjusting the threshold level based upon an application associated with the authentication process.

10. The method of claim 1, wherein the threshold level of similarity is established by the user.

11. An information handling device, comprising:
at least one sensor;
a processor;
detect at least two biometric inputs provided by a user during an authentication process;
authenticate the user responsive to determining that at least one biometric input of the at least two biometric inputs shares a threshold level of similarity with stored biometric information;
determine that another biometric input of the at least two biometric inputs does not share the threshold level of similarity with the stored biometric information; and
update the stored biometric information with retained characteristics of the another biometric input.

12. The information handling device of claim 11, wherein each of the at least two biometric inputs is associated with a biometric type.

13. The information handling device of claim 12, wherein the biometric type is selected from the group consisting of face recognition, iris recognition, fingerprint recognition, voice recognition, and behavioral recognition.

14. The information handling device of claim 12, wherein the instructions executable by the processor to update comprise instructions executable by the processor to update the biometric type associated with the another biometric input in the stored biometric information.

15. The information handling device of claim 11, wherein the instructions executable by the processor to update comprise instructions executable by the processor to update the stored biometric information responsive to identifying that the another biometric input does not share the threshold level of similarity with the stored biometric information for a predetermined number of iterations of the authentication process.

16. The information handling device of claim 11, wherein the instructions executable by the processor to update comprise instructions executable by the processor to update the stored biometric information responsive to identifying that the another biometric input does not share the threshold level of similarity with the stored biometric information for a predetermined number of iterations of the authentication process conducted within a predetermined period of time.

17. The information handling device of claim 11, wherein the instructions executable by the processor to update comprise instructions executable by the processor to automatically update the stored biometric information without receiving additional training input.

18. The information handling device of claim 11, wherein the instructions are further executable by the processor to:
receive, after the updating, the another biometric input in another iteration of the authentication process; and
identify that the another biometric input shares the threshold level of similarity with the stored biometric information.

19. The information handling device of claim 11, wherein the instructions are further executable by the processor to adjust the threshold level based upon an application associated with the authentication process.

20. A product, comprising:
a storage device that stores code, the code being executable by a processor and comprising:
code that detects at least two biometric inputs provided by a user during an authentication process;
code that authenticates the user responsive to determining that at least one biometric input of the at least two biometric inputs shares a threshold level of similarity with stored biometric information;
code that determines that another biometric input of the at least two biometric inputs does not share the threshold level of similarity with the stored biometric information; and
code that updates the stored biometric information with retained characteristics of the another biometric input.
